(19) United States
(12) Patent Application Publication
(10) Pub. No.: US 2014/0184667 A1
(43) Pub. Date: Jul. 3, 2014

(54) DISPLAY DEVICE WITH BINARY MODE AMOLED PIXEL PATTERN

(71) Applicant: NVIDIA Corporation, Santa Clara, CA (US)

(72) Inventor: Shuang Xu, Shenzhen (CN)

(73) Assignee: NVIDIA CORPORATION, Santa Clara, CA (US)

(21) Appl. No.: 13/730,525

(22) Filed: Dec. 28, 2012

(51) Int. Cl. G09G 3/32

(52) U.S. Cl. CPC G09G 3/3233
USPC 345/692; 315/294; 345/77

(57) ABSTRACT

An AMOLED display panel comprising a plurality of color elements in each pixel with each of the color elements comprising a discrete plurality of illuminating units associated with a plurality of transistors operating in a binary mode. The plurality of illuminating units have different sizes in accordance with 2ⁿ size, where n is the illuminating unit's number. n may also be the bit position of the bit line that controls the illuminating unit. The collective luminance of each color element can be digitally controlled by selectively activating a combination of the discrete illuminating units to their nominal luminance. The discrete plurality of illuminating units in each pixel may be directly controlled by RGB pixel data without the requirement for digital analog conversion.

### TECHNICAL FIELD

The present disclosure relates generally to the field of display devices and more specifically to the field of light-emitting diode display panels.

### BACKGROUND

An Organic Light-Emitting Diode (OLED) display consists of a matrix of Organic Light-Emitting Diode (OLED) pixels that generate light upon electrical activation. Conventionally, luminance of each OLED increases with more current flowing to it. Typically, this continuous current flow is controlled by at least two transistors at each pixel, one to start or stop the charging of a storage capacitor and the second to provide a voltage source at the level needed to create a constant current to the pixel. In a commonly adopted RGB color model, each light emitting element, i.e., pixel, comprises a red (R) OLED element, a green (G) OLED element, and a blue (B) OLED element for emitting red color, green color and blue color light, respectively. A pixel can express a desired color in a certain frame by mixing light of the three colors from respective light emitting elements. Typically, a system encodes pixel color values by devoting 8 bits to each of the R, G, and B components for control.

One approach to achieve control of an OLED display is to use an active matrix thin-film-transistor (TFT) backplane in an Active matrix Organic Light-Emitting Diode (AMOLED) display. The active matrix functions as switches to control the current flowing to each individual color element in each frame. Conventionally, the current flowing to each OLED is continuous and controlled by at least two TFTs, the first one for activating and deactivating the charging of a storage capacitor, and the second one for providing a voltage required to drive a constant current of intended level to control the luminance of the color element. Since the second transistor operates in its linear region, a considerable fraction of the power can be consumed by the internal resistance of the second transistor which wastes a significant amount of valuable power, especially when used in a mobile computing device fitted with a limited size battery. For example, the TFT transistors in an AMOLED display device may consume 40-60% of the power supplied to drive the AMOLED display device.

Further, in a conventional design, since luminance of each OLED is driven by a continuous current through an associated transistor, the binary color values, e.g. in the format of a 8:8:8 byte, usually have to be converted to analog data through a Digital-Analog-Converter (DAC) in a timing controller, which complicates the circuit design in the timing control logic.

Moreover, a display device for a portable device is often used in a wide range of ambient light levels. Conventionally, as the ambient light level increases, the luminance contrast decreases due to a fixed brightness emitted from the display panel. Although setting the display panel luminance constantly at its maximum level would ensure the images are visible in the widest range of ambient light levels, the unnecessarily brightness increases power consumption, and shortens operating lifetime of the display panel. Also, excessive contrast between the displayed images and dark ambient environments may cause eye discomforts.

### SUMMARY OF THE INVENTION

Therefore, it would be advantageous to reduce the power consumed by the transistors in an AMOLED display device and thereby increase power consumption efficiency of the display device. It would also be advantageous if the timing control logic for such a device can be simplified. Moreover, it would be also advantageous to be capable of adjusting the global luminance of a display panel in response to ambient light level.

Accordingly, embodiments of the present disclosure provide a mechanism to reduce power consumption by using transistors operating in a binary on/off mode to drive an array of OLEDs. The mechanism also allows for simplified designs of timing control logic and global luminance control of the display device. Embodiments of the present disclosure advantageously include an AMOLED layer with each color element comprising a discrete array of OLED junctions coupled to a plurality of transistors. Thus, luminance of the color element can be digitally controlled by turning on a selected combination of the transistors and thereby activating luminance of the associated OLED junctions. The plurality of OLED junctions of a respective color element vary in size in accordance with the value of the binary digit to which they are controlled. In one embodiment, the plurality of junctions that make up a color element may vary in size according to 2ⁿ, where n is the junction number and may correspond to a bit position of a control color bit that that controls the junction. The color bit is located within a color byte for controlling the entire color element.

In one embodiment of the present disclosure, a flat panel display apparatus comprises a cathode layer, an anode layer, an OLED layer and a plurality of sets of transistors coupled to the OLED layer. The OLED layer comprises a plurality of pixels arranged in a matrix. Each pixel comprises a plurality of color elements, and each of the plurality of color elements comprises a plurality of diode junctions arranged in a pattern. Each transistor controls a corresponding diode junction in a binary mode by a respective bit of a respective binary color value. A nominal luminance of each diode junction of a color element may correspond to a binary value represented by a respective bit position of a respective bit in a corresponding binary color value. Each transistor may be further coupled to a storage device operable to store the binary color value. The global luminance of the pixels may be adjustable by adjusting a voltage across the cathode and anode of the display panel. The transistors may be integrated on a thin film transistor TFT layer.

In another embodiment of the present disclosure, a system comprises a memory, a display panel and a display control logic, where the display panel comprises a cathode layer, an anode layer an AMOLED layer and a plurality of switches coupled to the AMOLED layer. The AMOLED layer comprises a plurality of pixels. Each of the plurality of pixels comprises a plurality of color element and each color element comprises a plurality of diode junctions coupled to a set of switches. The display control logic is operable to control luminance of each diode junction of respective color element by controlling a respective switch. The switches may be configured by transistors operating in on/off mode. Each of the transistors may have the gate coupled to a bit of corresponding binary color value provided by the display control logic, the drain coupled to the anode layer, and a source coupled to an associated diode junction. The total number of the plurality of diode junctions in a respective color element may be equal to a total number of bits in a corresponding binary color value, and each diode in a respective color element may have nominal luminance proportional to 2ⁿ, where n is the bit position of the bit controlling the diode. The system may further comprise a plurality of flip-flops coupled to the plurality of switches.

In another embodiment of the present disclosure, a method for displaying images on a display device comprises receiving image data that comprises a binary number representing luminance of a color element of a corresponding pixel of the display device and the color element comprises a plurality of discrete illuminating units. The method further comprises controlling each discrete illuminating unit individually between a first state and a second state with a respective bit of the binary number. The discrete illuminating units may comprise OLEDs coupled to transistors. The transistors may be configured to receive a respective bit of a binary number and provide binary control to the associated OLED. Each discrete illuminating unit in a color element may have nominal luminance proportional to 2ⁿ, where n indicates a bit position of a respective bit of the binary number used to control the illuminating unit.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1 depicts an exemplary layout of the pixels and color elements in an organic light emitting diode (OLED) display panel in accordance with an embodiment of the present disclosure.

FIG. 2A depicts an exemplary layout of diode junctions fabricated in rectangular shapes of varying sizes in an individual color element in accordance with one embodiment of the present disclosure.

FIG. 2B depicts an exemplary layout of the diode junctions fabricated in circular shapes of varying sizes in an individual color element in accordance with another embodiment of the present disclosure.

FIG. 3 is a block diagram illustrating a display control system configuration associated with an organic light emitting diode (OLED) display panel in accordance with an embodiment of the present disclosure.

FIG. 4 depicts an exemplary circuit configuration used to control the diode junctions in an individual color element in accordance with one embodiment of the present disclosure.

FIG. 5A is a flow diagram illustrating a method for digitally driving the diode junctions directly using a RGB pixel data in accordance with an embodiment of the present disclosure.

FIG. 5B is a flow diagram illustrating a method for driving the pixels with a decoded RGB pixel data in accordance with an embodiment of the present disclosure.

FIG. 6 is a block diagram illustrating a configuration of a mobile computing system comprising an AMOLED display panel in accordance with an embodiment of the current application.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### Notation and Nomenclature

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or display devices. When a component appears in several embodiments, the use of the same reference numeral signifies that the component is the same component as illustrated in the original embodiment.

### Display Device with Binary Mode Amoled Pixel Pattern

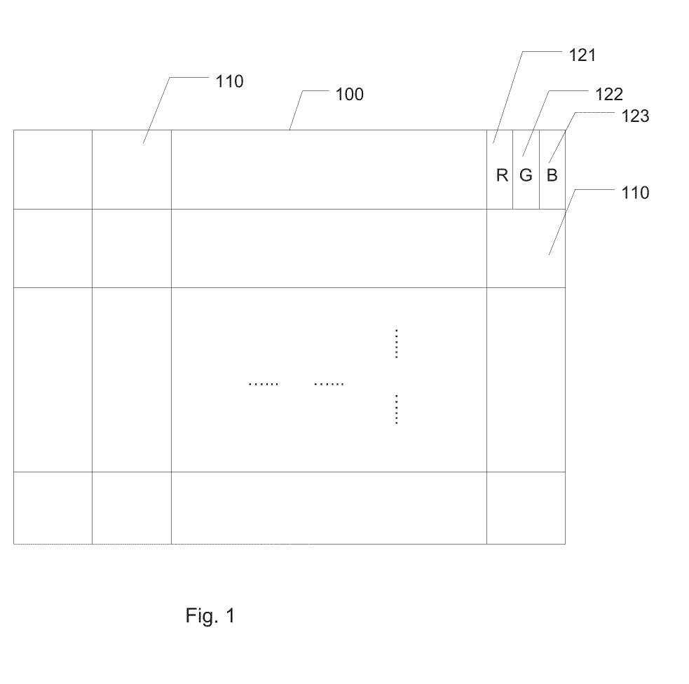

FIG. 1 depicts the layout of an array of color pixels and individual color elements in an organic light emitting diode (OLED) display panel 100 in accordance with an embodiment of the present disclosure. The display panel 100 comprises an array plurality of rows and columns of pixels 110 arranged in a two dimension matrix. In this embodiment, each pixel consists of three color elements represented as R (red) 121, G (green) 122 and B (blue) 123, e.g., the RGB model. The color of each pixel in a certain frame may be specified by a 24-bit binary color value, with 8 bits allocated for each color element, represented as 8:8:8. In some other embodiments, a different data format may be used to control an RGB model display, such as a 16 bit binary with 5 bits for each of red, green and blue color elements, and 1 bit for transparency. In still some other embodiments, a different color model, associated with a suitable color value format, may be used, such as RGBA, CMY, CMYK, YUV, YCbCr, YCC, YCoCg, HSV, HLS, and YCCK and CIE XYZ.

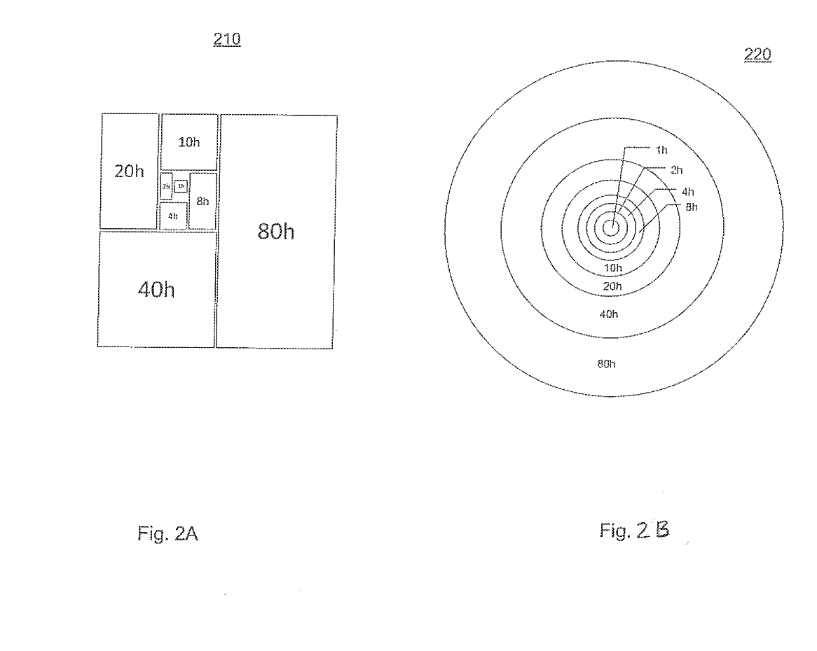

Referring to FIGS. 2A and 2B, each of the color elements on the OLED display panel in accordance with embodiments of the present disclosure comprises a set of discrete illuminating segments arranged in a known pattern, where the luminance of each discrete illuminating segment may be separately controlled in an on/off mode, also known as binary mode. Accordingly, the collective luminance of the color element can be controlled by activating a selected combination of discrete segments. For instance, if an intensity of 100 h is requested, the junctions corresponding to 80 h and 20 h may be activated and all other remain off, e.g., 10100000B. If a value of 12 h is requested, then the 8 h and 4 h junctions are activated only, e.g., 00001100B. Any number of junctions, or none, can be activated at any time.

The discrete nature of each color element advantageously eliminates the need for linear drive on the current or voltage applied to each color element, thereby saving power consumed on the associated controlling elements, e.g. the transistors. In addition, the elimination of linear control advantageously eliminates the need for digital-analog conversion as required to generate a linear control value by the prior art, and consequently leads to significantly simplified timing control logic.

In some embodiments, each of the discrete segments may be a separate diode junction. In some other embodiments, each of the discrete segments may further comprise a number of discrete diode junctions.

FIG. 2A depicts the layout of the set of diode junctions fabricated in rectangular shapes in an individual color element 210 in accordance with one embodiment of the present disclosure. The color element 210 comprises 8 diode junctions of varying sizes according to 2ⁿ where n is the junction number. The nominal luminance of each diode is proportional to its illuminating area. In this embodiment, each respective diode junction in the color element 210 has nominal luminance or size proportional to 2ⁿ, where n=1, 2, . . . , 8 and corresponds to the junction number, respectively. Represented in hexdecimals as labeled in FIGS. 2A and 2B, the diodes have areas proportional to 1 h, 2 h, 4 h, 8 h, 10 h, 20 h, 40 h and 80 h, respectively. In this pattern, a commonly used 8-bit binary value, for example, for a red element, can be advantageously used directly to control the luminance of each diode junction in a binary mode without requiring for digital to analog encoding/decoding because the nominal luminance of each diode corresponds to a binary value directly represented by the respective bit position of the respective bit in the byte that controls the junction. Thus, the luminance of the red element can be varied in 256 or 2⁸ steps. For example, given a binary color value of 10000001B for a red element in a particular pixel in a certain frame, the largest diode (with an area proportional to 80 h, or 2⁸) and the smallest diode (with an area proportional to 1 h, or 2¹) are actuated to illuminate as instructed by logic “1” while the rest remains off as instructed by logic “0”.

FIG. 2B depicts the layout of the diode junctions fabricated in circular shapes in an individual color element 220 in accordance with another embodiment of the present disclosure. The circular shape pattern may provide the benefit of symmetric illumination within each color element. Similarly, each circular diode in the color element 220 has nominal luminance or size proportional to 2ⁿ, where n=1, 2, . . . , 8 and represents the junction number, respectively, and can be controlled individually in a binary mode by an 8-bit binary color value. As can be appreciated by the persons having ordinary skills in the art, the flat panel display used in accordance with the present disclosure may comprise illuminating units, such as OLEDs, fabricated in many other suitable shapes.

In some embodiments, each color element may comprise a different number of segments from the number of bits in a control byte. In such cases, the control byte may be converted, e.g. via encoding or decoding, to a binary number in order to control the segments to operate in binary mode correctly. In some other embodiments, more than one segment may be grouped together and controlled by a control bit as a unity.

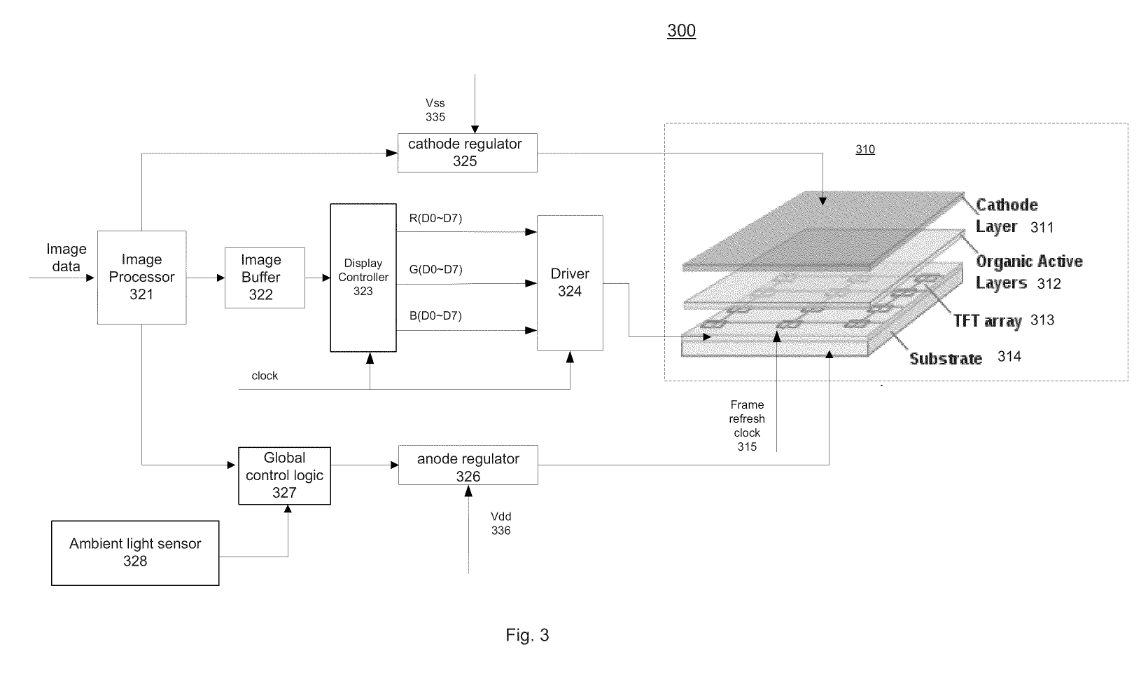

FIG. 3 is a block diagram illustrating an exemplary configuration of a display control system 300 associated with an organic light emitting diode (OLED) display panel 310 in accordance with an embodiment of the present disclosure. The display control system comprises an image processer 321, an image buffer 322, a display controller 323, a data driver 324 coupled to the OLED panel 310. The OLED display panel 310 comprises a cathode layer 311 coupled to a cathode voltage, Vss 335, organic active layers 312, a Thin-Film-Transistor (TFT) layer 313, and a substrate 314 coupled to the anode voltage, Vdd 336 acting as an anode. It is appreciated that the TFT layer 312 comprises a matrix of transistors coupled to respective illuminating units in the organic active layers 312. In the example of FIG. 2A, since each color element contains 8 junctions, then each color element requires 8 transistors from the TFT layer to control thereof.

The TFTs may be formed by a well known variety of substrates, including crystalline silicon, poly-silicon and amorphous silicon, where poly-silicon substrates may be processed under low and high temperature. Low-Temperature Poly-Silicon (LTPS) can be built on common low-cost glasses, while High Temperature Poly-Silicon (HTPS) needs quartz plate.

According to the illustrated embodiment in FIG. 3, an image data is transmitted to an image processor 321 and processed therein. The processed image data is forwarded to the display controller 323 after being buffered in the image buffer 322. The display controller is capable of generating an 8:8:8 byte representing the color value specified for each color element of one pixel located in the OLED display panel 300 in each frame. The binary color values are then converted to driving signals in the driver 324 and control the transistors on the TFT matrix 313 to operate in a binary mode. When a transistor on the TFT array 313 is switched on, the associated discrete segment in a particular color element is actuated and emits light to its nominal luminance. The TFT array is also coupled to a frame refresh clock 315 for frame changes.

The global luminance of the display panel 300 can be advantageously adjusted in response to the ambient light level detected by the ambient light sensor 328. For example, if the ambient light sensor senses the ambient light becomes brighter, the global control logic 327 can instruct the anode regulator 326 to output a reduced voltage on the anode layer 314. As a result, the luminance of the display panel 310 decreases. This global brightness value can be adjusted in analog fashion.

In some embodiments, the organic active layers 312 may be formed based on small-molecules technology by thermal evaporation. In some other embodiments, the organic active layers 312 may be polymer layers processed by spin coating. In some other embodiments, the OLED display panel may include a diffusive layer (not shown).

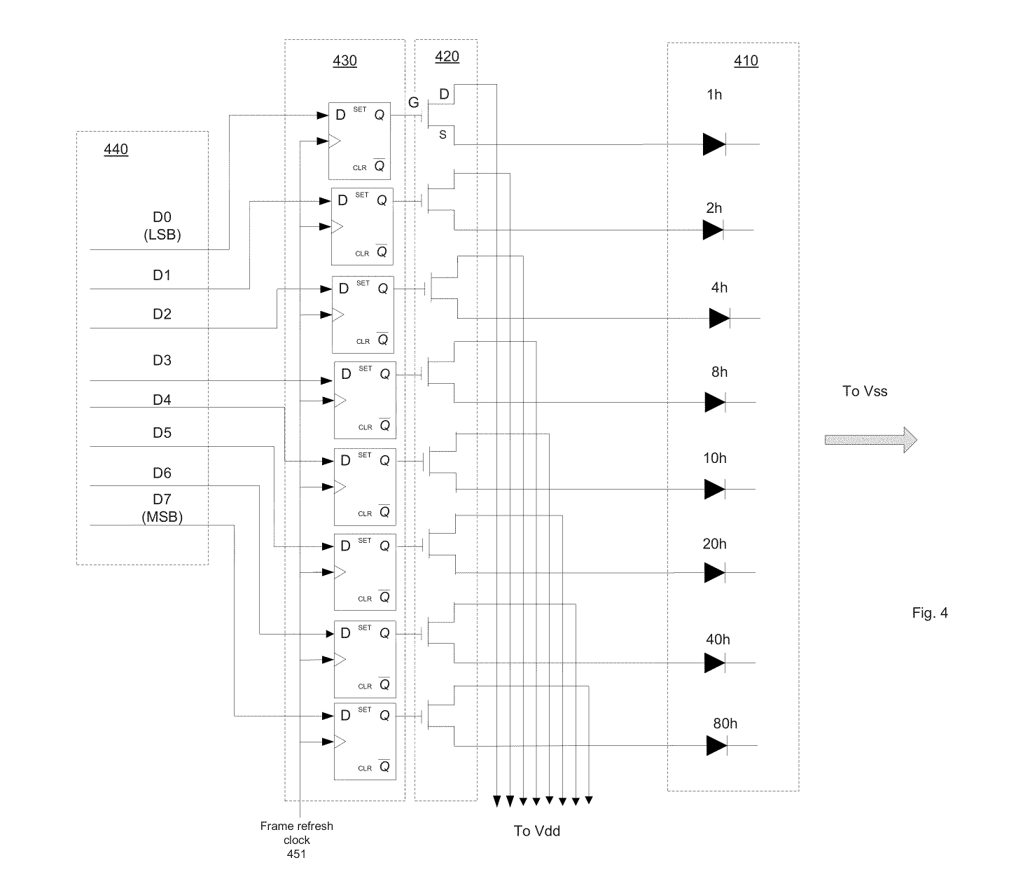

FIG. 4 depicts a configuration of an exemplary circuit 400 used to control the light emitting diodes 410 in an individual color element in accordance with one embodiment of the present disclosure. The color element 410 comprises 8 diodes, with respective nominal luminance proportional to 1 h, 2 h, 4 h, 8 h, 10 h, 20 h, 40 h, and 80 h in hexdecimal. The junctions are shown in FIG. 2A for instance. The cathodes 411 of the diodes 410 are coupled to the anode voltage applied on the display panel. The anode 412 of each diode 410 is couple to a source of a respective NMOS transistor 420. The drain of each transistor 420 is coupled to the cathode voltage applied on the display panel, and the gate of each transistor 420 is controlled by a respective bit of a binary color value 440. As illustrated, the least significant bit (LSB or D0) of a binary color value is used to control the smallest diode (1 h) and the most significant bit (MSB, or D7) is used to control the largest diode (80 h).

In this configuration, when the gate of an individual transistor 420 receives a logic “1” from a corresponding bit of the byte 440, the corresponding transistor 420 acts as a very low resistance, and allows the anode of the associated diode junction to be substantially at the voltage of Vdd, thereby activating the associated diode 410 to illuminate. On the other hand, if the gate of the transistor 420 receives a logic “0”, the associate diode remains off. Thus, each diode 410 works between an “on” and an “off” mode due to the binary mode operation of the associated transistor.

In some embodiments, as illustrated in FIG. 4, a flip-flop circuit 430 coupled to the frame refresh clock 451 can be employed to store a respective bit of the binary color value 440, and output the respective bit to control the transistor 420. In contrast, the prior art uses capacitors or the parasitic capacitance on the transistors to store the voltage for control. Due to leakages from the capacitors, periodic recharging may be required to maintain the voltage level, accounting for significant power consumption. The embodiment illustrated in FIG. 4 advantageously eliminates the need for periodic recharging because of the utilization of flip-fops, and thereby reduces power consumption.

In some embodiments, the flip-flops may be integrated on the TFT layer. In some other embodiments, they may be disposed in the driver or other suitable integrated circuits in the system.

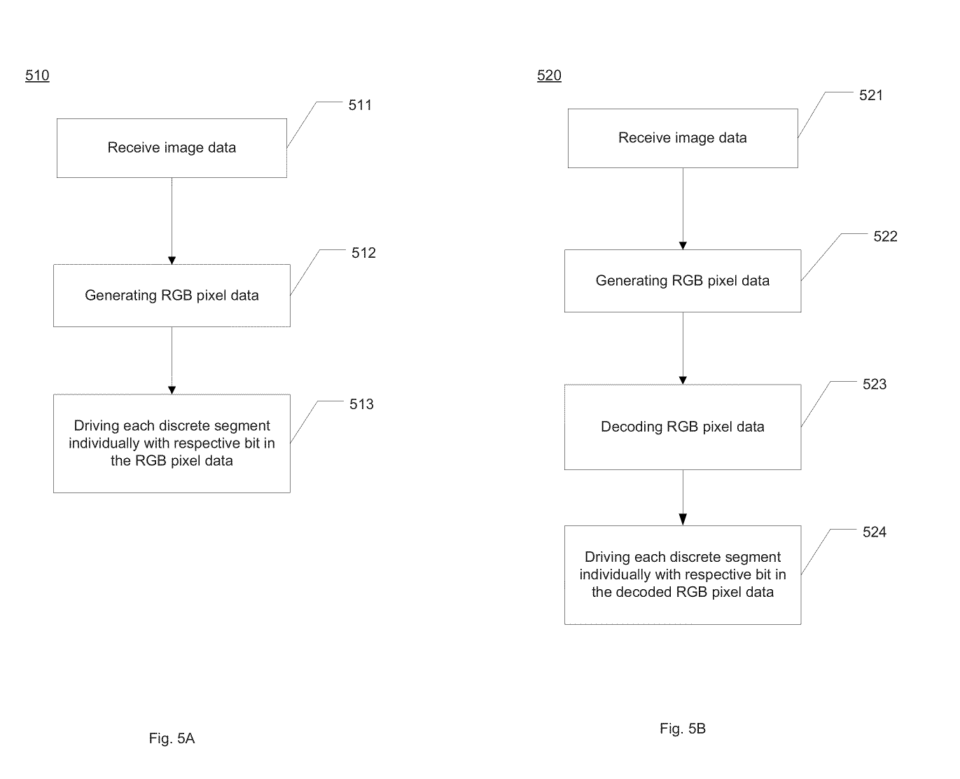

FIG. 5A is a flow diagram illustrating an exemplary method 510 for directly driving the discrete illuminating segments in a pixel using a RGB pixel data in accordance with an embodiment of the present disclosure. In this embodiment, each bit in a RGB color byte corresponds to and can directly control a respective illuminating segment in the display panel. At 511, an image data is received by the display control system. At 512, an RGB pixel data is generated to control the OLED display panel. At 513, the RGB pixel data is used to drive a respective illuminating segment directly in a respective color element with a respective bit.

FIG. 5B is a flow diagram illustrating an exemplary method 520 for driving discrete illuminating segments in a pixel with a decoded RGB pixel data in accordance with an embodiment of the present disclosure. The method 520 may be applicable when the format of an RGB pixel is incompatible with the data arrangement of the segments in a pixel, where the RGB pixel data is first converted to a compatible format to drive the diodes. Thus the method 520 comprises decoding the RGB pixel data at 523 after receiving image data at 521, generating a RGB pixel data at 522. At 524, the decoded RGB pixel data is used to drive illuminating segments.

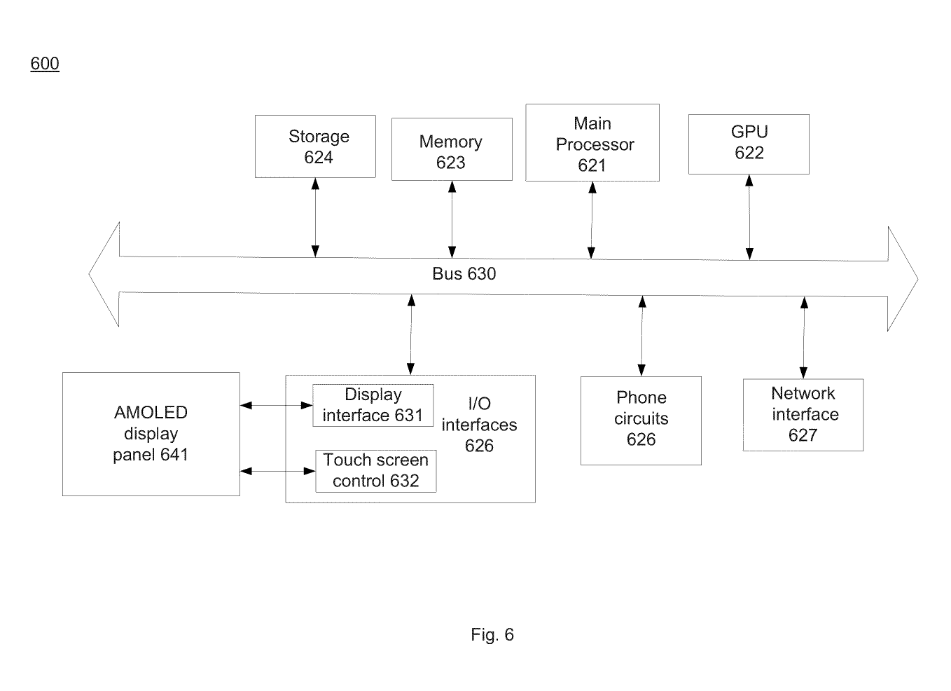

An AMOLED display panel comprising binary mode discrete illuminating segments in each color pixel in accordance with the present disclosure can be applied in any type of devices that require a display panel, such as a laptop, a cell phone, a personal digital assistance (PDA), a touchpad, a desktop monitor, a game display panel, TV, a controller of a machine, etc. FIG. 6 is a functional block diagram illustrating the configuration of a mobile computing device 600 that comprises an AMOLED display 641 having binary mode discrete illuminating segments coupled with other functional components in accordance with an embodiment of the present disclosure. The AMOLED display 641 may function as a touchscreen. In some embodiments, the mobile computing device 600 can provide computing, communication and /or media play back capability. The mobile computing device 600 can also include other components (not explicitly shown) to provide various enhanced capabilities. The AMOLED display 641 is coupled to a display interface 631 and a touchscreen control logic 632 in accordance with the illustrated embodiment.

According to the illustrated embodiment in FIG. 6, the computing system 600 comprises a main processor 621, a memory 623, an optional Graphic Processing Unit (GPU) 622 for processing graphic data, network interface 627, a storage device 624, phone circuits 626, I/O interfaces 625 which include an display interface 631 to communicate with the display panel 641 and a touch screen control 632, and a bus 630, for instance.

The main processor 621 can be implemented as one or more integrated circuits and can control the operation of mobile computing device 600. In some embodiments, the main processor 621 can execute a variety of operating systems and software programs and can maintain multiple concurrently executing programs or processes. The storage device 624 can store user data and application programs to be executed by main processor 621, such as video game programs, personal information data, media play back programs. The storage device 624 can be implemented using disk, flash memory, or any other non-volatile storage medium.

Network or communication interface 627 can provide voice and/or data communication capability for mobile computing devices. In some embodiments, network interface can include radio frequency (RF) transceiver components for accessing wireless voice and/or data networks or other mobile communication technologies, GPS receiver components, or combination thereof. In some embodiments, network interface 627 can provide wired network connectivity instead of or in addition to a wireless interface. Network interface 627 can be implemented using a combination of hardware, e.g. antennas, modulators/demodulators, encoders/decoders, and other analog/digital signal processing circuits, and software components.

I/O interfaces 625 provide communication and control between the mobile computing device 600 with other external I/O devices (not shown), e.g. a computer, an external speaker dock or media playback station, a digital camera, a separate display device, a card reader, a disc drive, in-car entertainment system, a storage device, user input devices or the like.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A flat panel display apparatus comprising:
a cathode layer;
an Organic Light-Emitting Diode (OLED) layer disposed proximate to said cathode layer wherein said OLED layer comprises a plurality of pixels arranged in a matrix, each of said plurality of pixels comprising a plurality of color elements and each of said color elements comprising a plurality of diode junctions arranged in accordance with a pattern;
a plurality of sets of transistors, each respective set of transistors corresponding to, and coupled to control, a respective color element of said OLED layer wherein each respective diode junction of said respective color element is coupled to a respective transistor of said respective set of transistors; and
an anode layer.

2. The flat panel display as described in claim 1 wherein each set of transistors is controlled by a binary color value applied thereto.

3. The flat panel display as described in claim 2 wherein each respective diode junction of a color element is controlled by a respective bit of a corresponding binary color value.

4. The flat panel display as described in claim 3 wherein a nominal luminance of each respective diode junction of a color element corresponds to an area size thereof.

5. The flat panel display as described in claim 4 wherein said area size of each respective diode junction corresponds to a binary value represented by a respective bit position of a respective bit in a corresponding binary color value applied thereto.

6. The flat panel display as described in claim 1 wherein each respective transistor of said respective set of transistors is operable to control luminance of a respective diode junction in a binary mode.

7. The flat panel display as described in claim 1 wherein each set of transistors are coupled with a set of storage devices coupled to a frame refresh clock, said set of storage devices operable to store said binary color value.

8. The flat panel display as described in claim 1 wherein a global luminance of said plurality of pixels of said display panel is adjustable by adjusting an analog voltage across said cathode layer and said anode layer.

9. The flat panel display as described in claim 1 wherein said plurality of sets of transistors are integrated on a Thin-Film-Transistor (TFT) layer.

10. A system comprising:
a memory storing image data;
a display panel, operable to display said image data, wherein said display panel comprises:
a cathode layer;
an anode layer;
an Active Matrix Organic Light-Emitting Diode (AMOLED) layer disposed proximate to said cathode layer and said anode layer, said AMOLED comprising a plurality of pixels arranged in a matrix, each of said plurality of pixels comprising a plurality of color elements and each of said plurality of color elements comprising a plurality of diode junctions; and
a plurality of sets of switches, each respective set of switches corresponding to, and coupled to control, a respective color element of said AMOLED layer wherein each respective diode junction of said respective color element is coupled to a respective switch of said respective set of switches; and
a display control logic, coupled to said memory and said plurality of sets of transistors, and operable to control luminance of each respective diode junction of said respective color element by controlling each of said respective set of switches.

11. The system as described in claim 10 wherein said plurality of sets of switches comprise a plurality of sets of transistors disposed in a Thin-Film-Transistor (TFT) layer, and wherein each of said plurality of sets of transistors in the TFT layer comprises a gate configured to receive a respective bit of a corresponding binary color value from said display control logic, a drain coupled to said anode layer, and a source coupled to a respective diode junction of said flat panel display.

12. The flat panel display as described in claim 10
wherein a total number of the plurality of diode junctions comprised in a respective color element is equal to a total number of bits in a corresponding binary color value, and
wherein each respective diode junction comprised in said respective color element has nominal luminance proportional to 2ⁿ, wherein n indicates a bit position of a respective bit in said corresponding binary color configured to control said each respective diode junction.

13. The system as described in claim 12 wherein said corresponding binary color value is an 8-bit binary number used in an RGB color model.

14. The system as described in claim 13 wherein said plurality of sets of switches are coupled to a plurality of storage devices, said plurality of storage devices coupled to a frame refresh clock, and configured to store said binary color and to control said each respective set of transistors.

15. The system as described in claim 10 wherein global luminance of said display panel is adjustable by varying a voltage across said cathode layer and said anode layer.

16. A method for displaying images on a display device, said method comprising
receiving image data, said image data comprising a binary number representing luminance of a color element of a corresponding pixel of said display device, said color element comprising a plurality of discrete illuminating units; and
controlling each of said plurality of discrete illuminating units individually between a first state and a second state with a respective bit of said binary number.

17. The method as described in claim 16, wherein said plurality of discrete illuminating units comprise Organic Light-Emitting Diodes (OLED).

18. The method as described in claim 16, wherein said plurality of discrete illuminating units in said color element are respectively coupled to a plurality of transistors, each of said plurality of transistors configured to receive a respective bit of said binary number, and to provide binary control to an associated illuminating unit.

19. The method as described in claim 18, wherein each respective discrete illuminating unit in said color element has nominal luminance proportional to 2ⁿ, wherein n indicates a bit position of a respective bit in said binary number configured to control said each respective discrete illuminating unit.

20. The method as described in claim 18, wherein said display device comprises an anode layer and a cathode layer coupled to a first voltage and a second voltage respectively, and wherein said method further comprises controlling global luminance of said display device by adjusting a difference between said first voltage and said second voltage.

21. The method as described in claim 16, wherein said binary number is an 8-bit binary number used in a RGB color model, and wherein a total number of said plurality of discrete illuminating units in said color element equals to 8.

22. The method as described in claim 16 further comprising decoding said binary number into a decoded binary number, wherein said controlling each of said plurality of discrete illuminating units individually comprises controlling each of said plurality of discrete illuminating units with said decoded binary number, and wherein a total number of said plurality of discrete illuminating unit in said color element is equal to a total number of bits in said decoded binary number.
